(19) United States
(12) Patent Application Publication
(10) Pub. No.: US 2023/0330452 A1
(43) Pub. Date: Oct. 19, 2023

(54) FACE MASK

(71) Applicant: Adil MAGAR, Edensor Park, New South Wales (AU)

(72) Inventor: Adil MAGAR, Edensor Park, New South Wales (AU)

(21) Appl. No.: 17/998,710

(22) PCT Filed: May 14, 2021
(86) PCT No.: PCT/AU21/50456

§ 371 Date: Nov. 14, 2022

(30) Foreign Application Priority Data
May 14, 2020 (AU) 2020901543

(51) Int. Cl. A62B 23/02; A41D 13/11

(52) U.S. Cl. CPC A62B 23/02; A41D 13/1107

(57) ABSTRACT

A face mask includes a shield and a filter carrier. The shield includes a shield body that defines an opening space from a lower periphery of the shield body. The shield body is made from waterproof, transparent, rigid or semi-rigid material. The opening space is formed in use at a lower portion of the face mask below the chin and opens rearwardly towards the user's neck. The opening space is fully covered by the filter carrier with a filter in use. The filter carrier and the filter are covered from the front by the shield body. The transparent shield body thus covers the bottom front portion of the user's face without any parts thereof blocking viewing the user's face. The filter carrier is shaped to extend across the opening space such that air moving in and out of the mask passes through the filter.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a face mask. The invention is primarily intended for protection against viruses transmitted via the air, spittle, or mucus but is not limited to this use, and can also be used for other applications such as workplace protection against dust, smoke and hazardous gas.

### 2. Description of Related Art Including Information Disclosed Under 37 CFR 1.97 and 37 CFR 1.98

Present face masks have the problem of not being fully effective and unattractive.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

The present invention provides a face mask comprising:
a shield comprising a body which is shaped and dimensioned to cover the lower front portion of a user's face including the nostrils and mouth, the shield body extending to a distance below the chin which defines an opening space from a lower periphery of the shield body to the user's chin or jaw,
a filter carrier mounted to a lower portion of the shield body to extend across the opening space in use between the user's chin or jaw and the lower periphery of the shield body such that air moving in and out of the mask passes through a filter carried by the filter carrier.

In one embodiment, the shield body is made from transparent material.

In another embodiment, the shield body comprises an upper peripheral edge which is shaped to follow the contours of the user's face, and a main mid-portion of the shield body is shaped to be spaced away from the user's face.

In another embodiment, the filter carrier comprises a structure having an upper edge which is flexible to seal with the user's chin or jaw in use, and a lower edge which follows and seals with an inside surface of the shield body.

In another embodiment, the shield body includes a lip protrusion formed across an inside surface thereof which is follows the outline of the lower edge of the filter carrier, such that the lower edge of the filter carrier can abut and seal therewith.

In another embodiment, the filter carrier comprises a number of openings between the upper edge and the lower edge defined by spaced structural bridges, wherein the bridges are flexible to allow the user to move their mouth freely in use.

In another embodiment, the filter extends across and covers the openings, the filter being removable.

In another embodiment, the filter carrier includes an attachment arm at a lower portion thereof for removable mounting to the shield body.

In another embodiment, the filter carrier is permanently attached to the shield body.

In another embodiment, the shield body includes a vertical mount slot at the lower periphery thereof and a horizontal mount slot spaced above the vertical slot, the attachment arm comprises a channel which receives the lower portion of the shield body with a horizontal protrusion at the distal end thereof which is inserted into the horizontal mount slot providing attachment to the shield body, and the attachment arm further including a vertical protrusion at the proximal end thereof which is received in the vertical slot to prevent lateral movement of the filter carrier relative to the shield body.

In another embodiment, the filter carrier includes a main body and a retainer with connection means therebetween, wherein the retainer is removable from the main body and the filter can be mounted between the main body and the retainer.

In another embodiment, the main body and the retainer comprise regularly spaced apertures, wherein the apertures in the main body the retainer are not aligned.

According to another first aspect, the present invention provides a face mask comprising a base having a cupped shaped body which is shaped and dimensioned to cover the lower front portion of a user's face, the body being transparent and shaped to be spaced away from the user's face, the body having an opening for a replaceable filter pad.

Preferably, the opening is disposed to be lower than the user's lips in use.

Preferably, the opening is aligned with the user's chin in use.

Alternatively, the opening is to be under the user's chin in use.

Preferably, the body comprises an edge having a resilient sealing strip for sealing with at least the front parts of the user's face.

Preferably, the body covers the respiratory parts of the face being the nose and mouth.

Preferably, the peripheral edge is shaped to follow the contours of the user's head around the respiratory parts from the nose bridge, cheeks, and under the chin.

Preferably, the body is made from waterproof, transparent, rigid or semi-rigid material.

Preferably, the body is made from resilient material.

Preferably, the body comprises mounting means for the filter pad around the opening.

Preferably, the face mask of further comprises a shield for covering the opening and protecting the filter.

Preferably, the body comprises a sealing edge formed across the body which engages the shield to seal therewith.

Preferably, the shield comprises a generally rigid or semi-rigid body which is shaped to cover the lower portion of the base body, downwards from the sealing edge.

Preferably, the shield is pivotably mounted to the body and can be moved from its normal lowered position to a raised position at which it does not cover the opening.

Preferably, the shield is spaced from the opening.

In another embodiment, the base body comprises a downwardly extending flange (29) at the lower section thereof which locates under the chin to act as a shield to protect the neck and direct airflow downwardly in use.

Preferably, the flange is flexible to allow neck movement.

Preferably, the base body opening comprises a perforated section having a plurality of holes.

Preferably, wherein the shield comprises baffles disposed below the opening in use which are used to reduce the speed of air travel in and out of the mask, and to stop traces of mucus and spittle in both directions being into and out of the mask.

Preferably, the shield includes an upwardly extending flange at a lower section thereof which is directed towards the base body, the flange having a plurality of spaced holes therein for airflow and which acts as an additional baffle.

Preferably, the flange engages and seals with the base body.

Preferably, the face mask further comprises a filter pad placed across the openings of the flange.

Preferably, the shield includes mounting means for a tissue membrane to be in front of the opening, the tissue membrane being for absorbing moisture, mucus and spittle.

The invention also provides a face mask comprising a base having a cupped shaped body which is shaped and dimensioned to cover the lower front portion of a user's face, the body having an opening for a replaceable filter pad, the opening being disposed to be lower than the user's lips in use.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 shows a face mask where (a) is a side elevation view and (b) is a perspective view.

FIG. 2 shows the base where (a) is a perspective view and (b) is a side elevation view.

FIG. 3 shows a perspective view and an elevation view of (a) the filter pad and (b) shows the mounting of the filter pad to the base body.

FIG. 4 shows a perspective view of (a) the shield, and (b) shows a schematic cross-section view of the shield sealing engagement with the base body.

FIG. 5 shows a perspective view of a face mask according to another embodiment.

FIG. 6 shows a face mask according to a further preferred embodiment of the present invention where (a) is a side elevation view and (b) is a side cross-section view.

FIG. 7 shows a perspective view of a face mask according to another embodiment.

FIG. 8 is an enlarged perspective view of the lower portion of the mask of FIG. 7.

FIG. 9 is a side elevation view of the mask of FIG. 7.

FIG. 10 is an exploded perspective view of the filter carrier for the mask of FIG. 7.

FIG. 11 is an exploded perspective view of the lower portion of the mask showing attachment of the filter carrier to the shield body.

FIG. 12 shows a perspective view of a face mask according to another embodiment.

FIG. 13 is an enlarged cross sectional view of the filter carrier and the shield body of the mask or FIG. 12.

FIG. 14 shows a perspective view of the filter and the internal lip protrusion of the shield body.

FIG. 15 is an exploded perspective view of the filter carrier with the filter.

### DETAILED DESCRIPTION OF THE INVENTION

It should be noted in the following description that like or the same reference numerals in different embodiments denote the same or similar features.

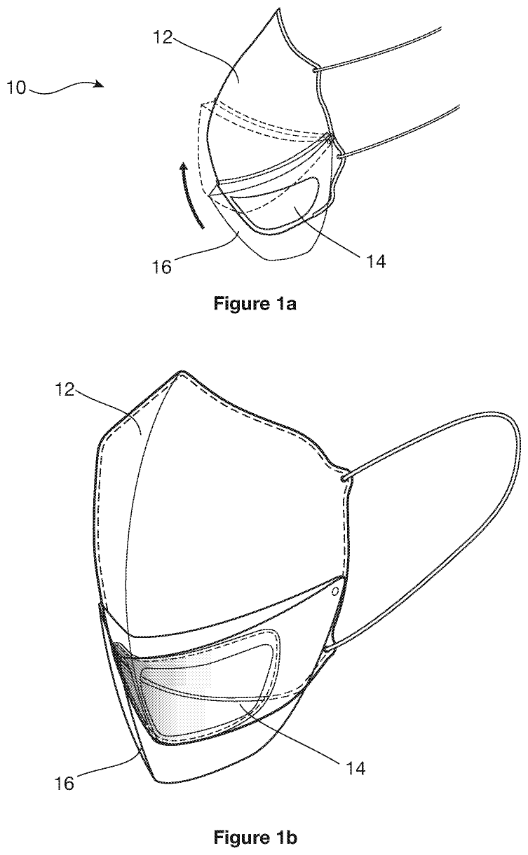

FIG. 1 shows a face mask 10 according to a preferred embodiment of the present invention. The face mask 10 comprises a base 12, a filter pad 14, and a shield 16.

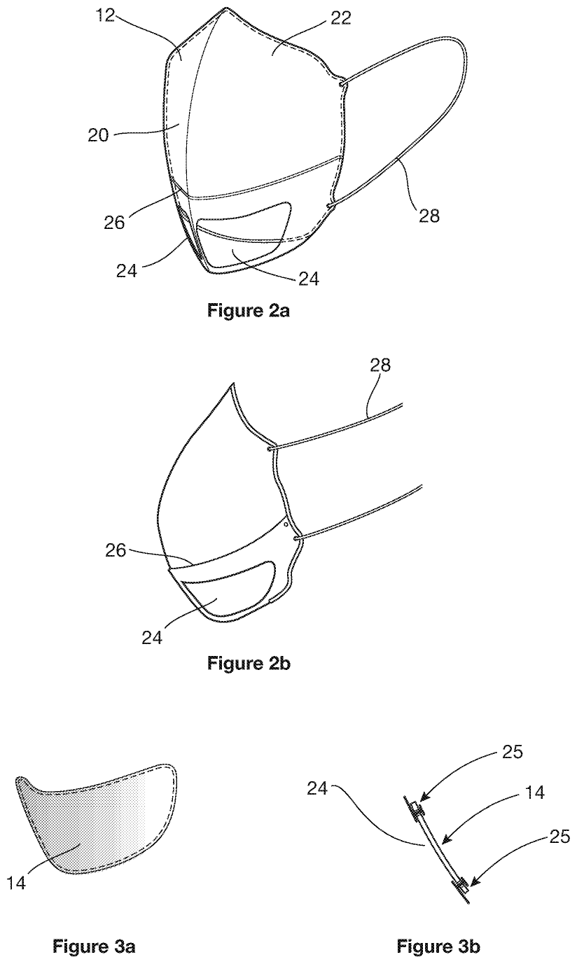

As shown in FIG. 2, the base 12 comprises a cupped shaped body 20 which is shaped and dimensioned to cover the lower front portion of a user's face, that is the respiratory parts being the nose and mouth. The body 20 comprises a peripheral edge 22 which is shaped to follow the contours of the user's head around the respiratory parts from the nose bridge, cheeks, and under the chin. In use, apart from the edge 22, the body 20 is shaped to be spaced away from the user's face. The body 20 in the embodiment is generally convex shaped to extend away from the user's face. The edge 22 includes a resilient strip such as silicon gel or strip to provide a seal with the user's skin and provide comfort.

In the embodiment, the body 20 is made from waterproof, transparent, rigid or semi rigid material. The body 20 is transparent to allow the user's face to be visible which improves social interaction and identification of the user. The body 20 is waterproof to avoid penetration or absorption of any moisture such as spittle or mucus from other people. The body 20 is made from rigid or semi-rigid material to maintain its shape to be spaced from the user's face, apart from the edges thereof. The material can be plastics, silicon or other suitable material. The material is preferably resilient in that it will go back into shape if impacted such as by the user's hand or other people.

The body 20 comprises an opening 24 at a lower portion thereof which is below the user's mouth in use. The opening 24 is thus generally aligned with the user's chin or below the chin. The opening 24 in this embodiment is in two portions with a structural bridge therebetween. The filter pad 14 is to extend across the opening 24 in use and cover the opening 24, and thus the edges of the opening 24 include mounting means for the filter pad 14 such as mounting posts, slots, hook and loop patches, or other suitable mounting means. The mounting means in the example shown comprises mounting posts 25 at the internal surface thereof to which edge openings of the filter pad 14 can extend through.

A sealing edge or lip 26 is formed across the body 20, extending between the side edges of the body 20 and slightly above the opening 24. The sealing edge 26 is for sealing with the face shield 16 as described below. Elastic ear hoops 28 or other suitable ear or head mounting straps are attached to the side edges of the body 20.

The filter pad 14 is adapted for filtering viruses, bacteria and/or other harmful substances and gases. In the embodiment, the filter pad 14 is N95 standard compliant and comprises mounting holes at the edges thereof corresponding to the mounting posts 25 which allows strong positive mounting but easy removal and replacement.

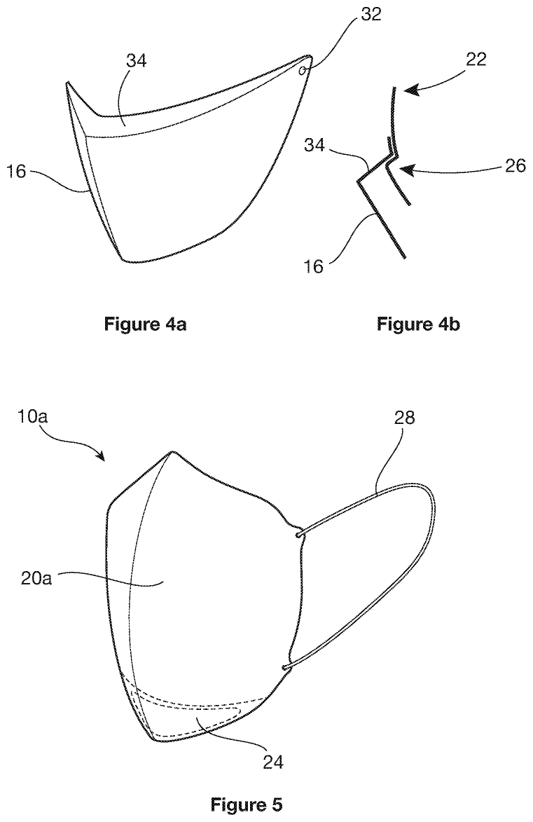

FIGS. 1 and 4 show the shield 16. The shield 16 comprises a generally rigid or semi rigid body which is shaped to cover the lower portion of the base body 20, downwards from the sealing edge 26. The shield 16 thus covers the filter pad 14 in its normal position. The shield 16 comprises mounting points 32 to allow for pivotable mounting to the base body 22, which allows the shield 16 to be moved from its normal lowered position to a raised position at which it does not cover the filter pad 14. The raised position is for when the user wants to speak to another person for example and wants to avoid the shield from blocking their voice. Alternatively, the shield 16 can be removable and quickly attachable instead of being pivotably mounted.

The shield 16 comprises an upper flange 34 which extends to the body base body 20, the flange 34 engaging and sealing with the sealing edge 26 in the normal position of the shield 16. The shield 16 is preferably shaped to be spaced away from the filter pad 14 for improved airflow.

The preferred embodiment thus provides a face mask which provides a number of advantages. The Main Mask Body is a clear see thru mask. This allows for no obstruction in identifying the user. The mask can be wiped down or washed if required. By having the filter opening located at the bottom and below the lips, it does not obstruct the user from being identified. There is a Gel around the edge of the mask which allows the mask to conform to the users face and creates a tight seal. The mask body tucks under the chin, which helps contain any spit or spray from surrounding people. There is enough volume inside the mask body keeping the mask and filter away from the face reducing condensation and drenching the filter. There are little anchor points around the filter, that allow for easy placement to replace the filter pad.

The shield is an adjustable spray and splatter shield which is a clear shield, and the shield protects both the user and surrounding people from spray. The shield can be easily cleaned and wiped down and is reusable. The shield when down protects the user's filtration pad from being infected and this extends the life of the pad. This allows for the user to slide the shield up to allow them to talk on a mobile phone or when they are in less risky scenario. The sealing edge in the base body and the shield flange creates a seal between the main mask and splatter shield.

The filtration pad is a replaceable pad. Subject to the user's needs, the pad can be replaced to suit the application—for virus, dust, carbon filter or other uses. The pad has holes at the edges thereof that line up with the mounting nipples that are fixed in the main mask body. This allows for the filter pads to be easily positioned accurately. A glue strip can also be provided around the perimeter of the filter to hold the filter in place.

FIG. 5 shows another embodiment of the face mask 10a. In this embodiment, the opening 24 is located under the user's chin, and thus the filter pad 14 is also disposed to be under the chin. The base body 20a in this case is extended to cover from the nose bridge to the bottom of the chin and the shield 14 is omitted. In other uses, the filter pad 14 can be omitted and replaced with a grill or remain just an opening.

Although a preferred embodiment of the present invention has been described, it will be apparent to skilled persons that modifications can be made to the embodiment shown.

The body can be made from opaque material and does not have to be transparent. The shield is optional and can be omitted. The shield can also be made to remain in a single position and does not have to be movable.

Ideally the internal surface of the body includes antibacterial and/or antifog treatment. The ear straps can be omitted and the body adapted to seal and attach to the user's face. The filter pad can be replaced with any air permeable material such as tissue paper, cloth, sponge or other material.

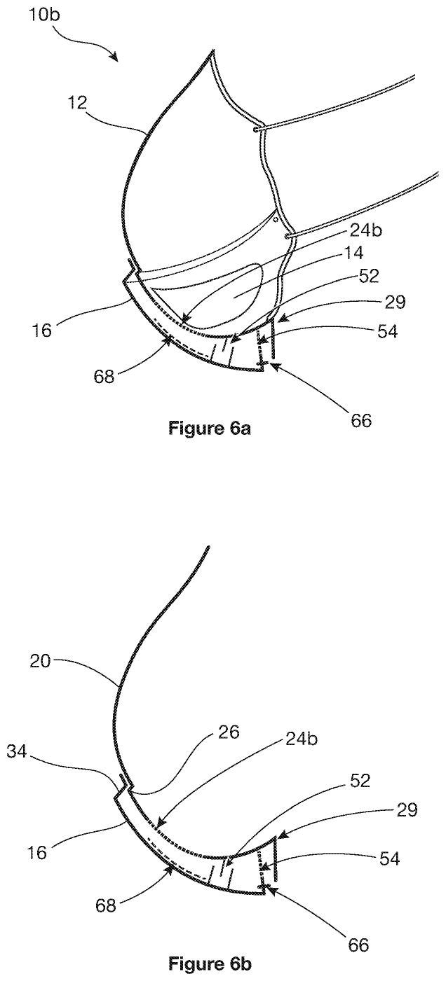

FIG. 6 shows a face mask 10b according to a further preferred embodiment of the present invention. The face mask 10b is similar to the face mask 10 and also comprises a base 12, a filter pad 14, and a shield 16. Similar parts are marked with similar reference numerals. The differences in features between the masks 10 and 10b are described below.

In the mask 10b, the base body 20 comprises a downwardly extending flange 29 at the lower section thereof which locates under the chin. The flange 29 thus acts as a shield to protect the neck and also direct exhaled airflow downwardly in use. The flange 29 is preferably flexible to allow neck movement.

The base body opening 24b in this embodiment is also modified into a perforated section having a plurality of smaller holes of the base body 20 instead of two big openings. The smaller holes allow 24b provide partial or slower airflow.

The mounting means for the filter pad 14 is similar to the mask 10 above.

The shield 16 in this embodiment comprises baffles 52 disposed below the opening 24b in use, which are used to reduce the speed of air travel in and out of the mask, and to stop traces of mucus and spittle in both directions being into and out of the mask.

The shield 16 in this embodiment also includes an upwardly extending flange 54 at a lower section thereof which is directed towards the base body 20. The flange 54 preferably engages and seals with the base body 20 and is disposed spaced from the flange 29. The flange 54 has a plurality of spaced holes therein for airflow and which acts as an additional baffle.

In another alternative embodiment, the filter pad 14 can be omitted, and replaced with a filter pad 66 placed across the openings of the flange 54. As a further alternative, the filter pad 66 can be an additional pad to the filter pad 14.

The shield 16 can also include mounting means for a tissue membrane 68 above the baffles 52 to be in front of the opening 24b. The tissue membrane 68 can be used to absorb moisture, mucus and spittle.

The features of the shield of the mask 10b can also be used for the mask 10a shown in FIG. 5.

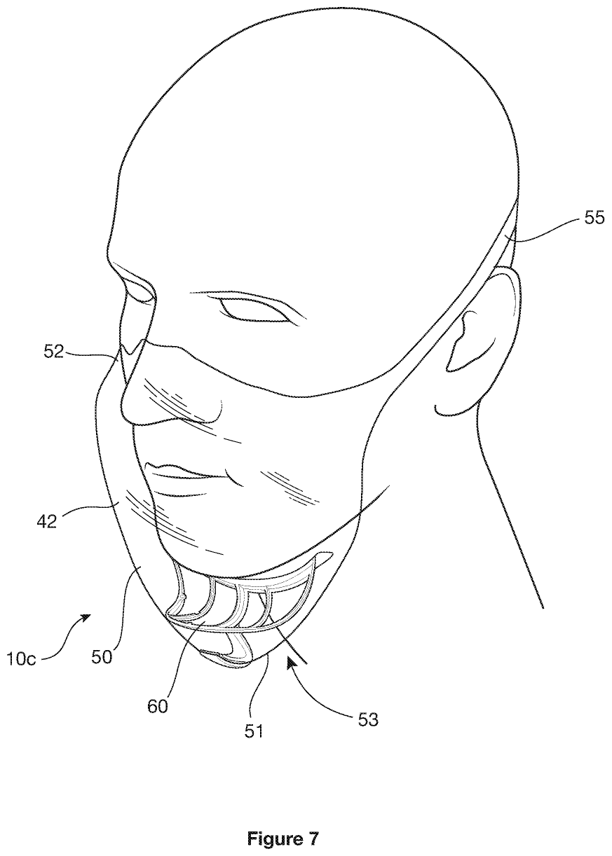

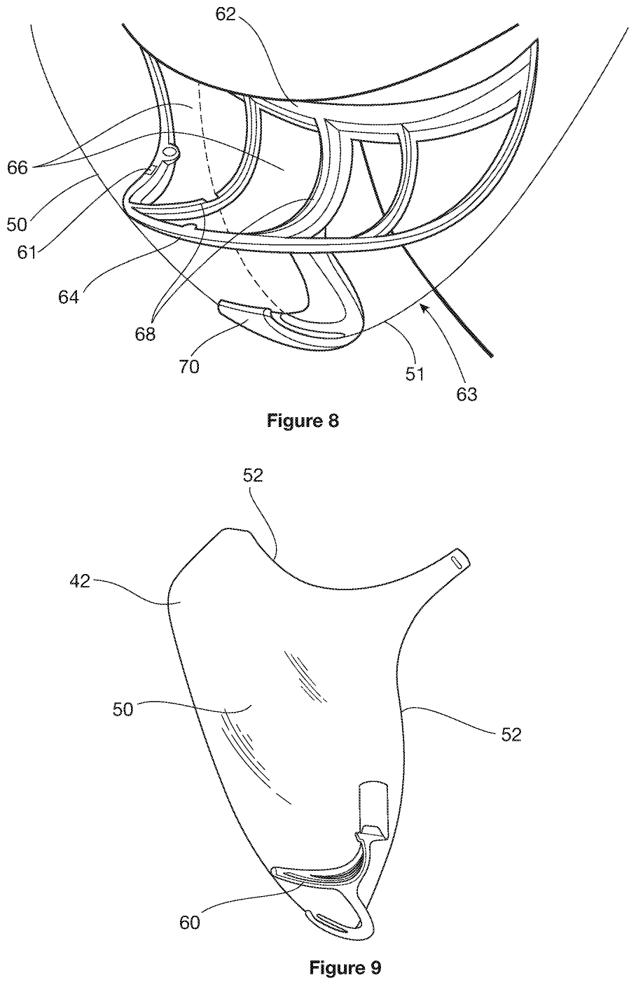

FIG. 7 shows a FIG. 1 shows a face mask 10c according to another preferred embodiment of the present invention. The face mask 10 comprises a shield 42 and a filter carrier 60.

The shield 42 comprises a shaped body 50 which is shaped and dimensioned to fully cover the lower front portion of a user's face, that is the respiratory parts being the nostrils and mouth. The body 50 comprises an upper peripheral edge 52 which is shaped to follow the contours of the user's head around the respiratory parts from the nose bridge, across to the cheeks and downwards therefrom, and down to under the chin. The shield body 50 extends to a distance below the chin, which defines an opening space 53 from a lower periphery 51 of the shield body 50 to the user's chin or jaw. The shield 42 thus follows the contours of the user's face except for under the chin at which the lower periphery 51 is spaced below the chin.

In use, apart from the upper peripheral edge 52, the main mid-portion of the shield body 50 is shaped to be spaced away from the user's face. The body 50 in the embodiment is generally convex shaped to extend away from the user's face. The upper peripheral edge 52 can include a resilient strip such as silicon gel or strip to provide a seal with the user's skin and provide comfort.

In the embodiment, the shield body 50 is made from waterproof, transparent, rigid or semi-rigid material. The shield body 50 is transparent to allow the user's face to be visible which improves social interaction and identification of the user. The body 50 is waterproof to avoid penetration or absorption of any moisture such as spittle or mucus from other people. The body 50 is made from rigid or semi-rigid material to maintain its shape to be spaced from the user's face, apart from the edges thereof. The material can be plastics, silicon or other suitable soft fitting material. The material is preferably resilient/flexible in that it will go back into shape if impacted such as by the user's hand or other people. The mask 10c includes a clear silicon strap 55 for full transparency to the user's face. In an alternative embodiment, the body 50 can be opaque and of a solid colour or include graphics or a pattern thereon.

The opening space 53 is formed in use at a lower portion of the face mask 10c below the chin and opens rearwardly towards the user's neck. The opening space 53 is fully covered by the filter carrier 60 with a filter 90 in use, which are thus both below the chin and do not cover the user's face in use. The filter carrier 60 and the filter 90 are covered from the front by the shield body 50. The transparent shield body 50 thus covers the bottom front portion of the user's face without any parts thereof blocking viewing the user's face.

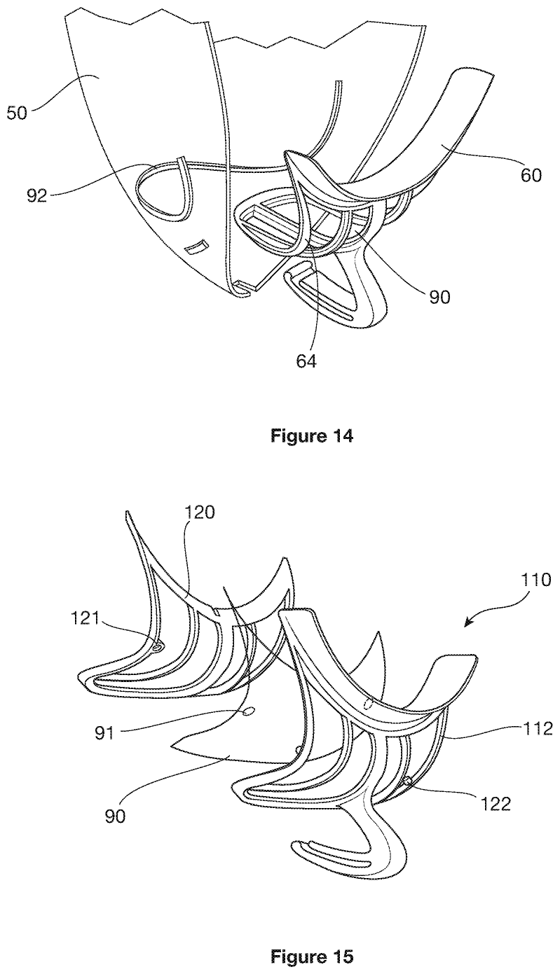

The filter carrier 60 is shaped to extend across the opening space 53 such that air moving in and out of the mask 10c passes through the filter 90. The filter carrier 60 comprises a flexible grill-like structure 61 having an upper edge 62 which is flexible and acts as a seat to seal with the user's chin or jaw in use, and a lower edge 64 which follows and seals with the inside surface of the shield body 50. The lower edge 64 in this embodiment is curved and extends from the ends of the upper edge 62. The structure 61 is shaped as generally concave in the example shown but can also be shaped in other forms. As shown in FIG. 14, the shield body 50 includes a lip protrusion 92 formed across the inside surface thereof which is curved and follows the outline of the lower edge 64, such that the lower edge 64 can abut and seal therewith. The filter carrier 60 comprises a number of openings 66 defined by spaced structural bridges 68 extending between the upper edge 62 and the lower edge 64. The bridges 68 are flexible to allow the user to move their mouth freely in use. The filter 90 extends across and covers the openings 66.

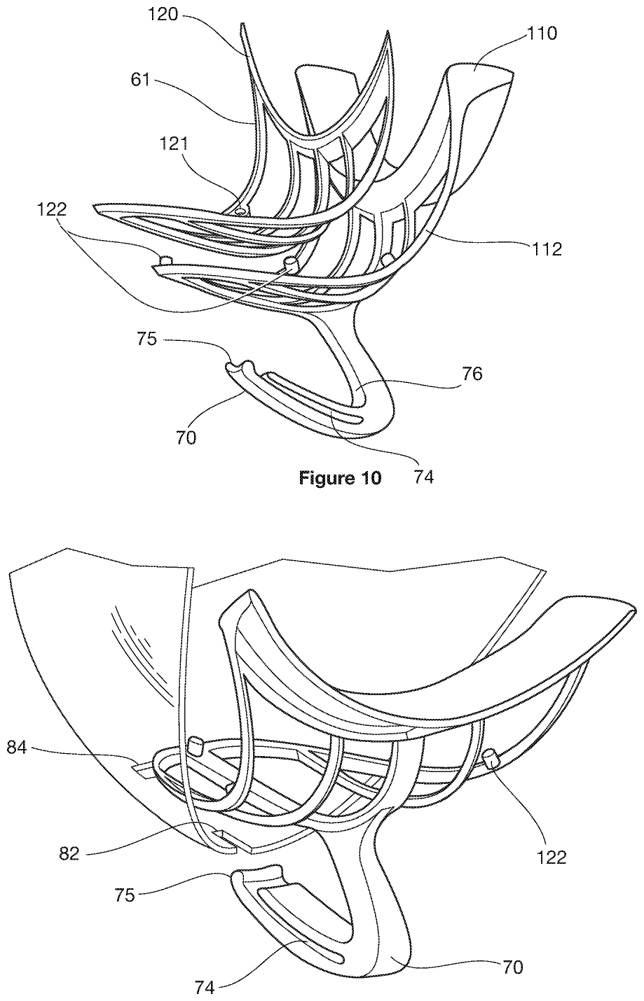

As best seen in FIGS. 10 and 11, the filter carrier 60 includes an attachment arm 70 at a lower portion thereof for mounting to the shield body 50. The shield body 50 includes a vertical mount slot 82 at the lower edge thereof and a horizontal mount slot 84 spaced above the vertical slot 82. The attachment arm 70 comprises a channel 74 which receives the lower portion of the shield body 50, with a horizontal protrusion 75 at the distal end thereof which is inserted into the horizontal mount slot 84, providing attachment to the shield body 50. The attachment arm 70 further includes a vertical protrusion 76 at the proximal end thereof which is received in the vertical slot 82 to prevent lateral movement of the filter carrier 60 relative to the shield body 50.

FIGS. 10 and 15 show additional details of the filter carrier 60. The filter carrier 60 includes a bracket 110 and a retainer 120. The bracket 110 comprises a main body 112 which is a lower portion of the grill-like structure 61, and the attachment arm 70. The retainer 120 comprises an upper portion of the structure 61 and closely matches the shape of the main body 112. Both the main body 112 and the retainer 120 thus comprise a generally concave grill-like structure. Connection means are provided between the bracket 110 and the retainer 120, such as corresponding apertures 121 and protrusions 122.

The retainer 120 is removable from the main body 112 of the bracket 110 so that the filter 90 can be placed/sandwiched therebetween, with the filter 90 extending across and covering the openings 66. The filter 90 includes apertures 91 which can be inserted into the protrusions 122 to assist with retaining its position. Attaching the retainer 120 to the main body 112 retains the filter 90 to the filter carrier 60. The main body 120 can include a peripheral lip which seals with the retainer 120 to prevent any fluid leaking from the edge of the filter.

The filter carrier 60 can be easily removed from the shield body 50 via the attachment arm 70. This allows the filter 90 to be removed and replaced as needed, and other types of filters can also be used with the filter carrier 60 depending on the requirements.

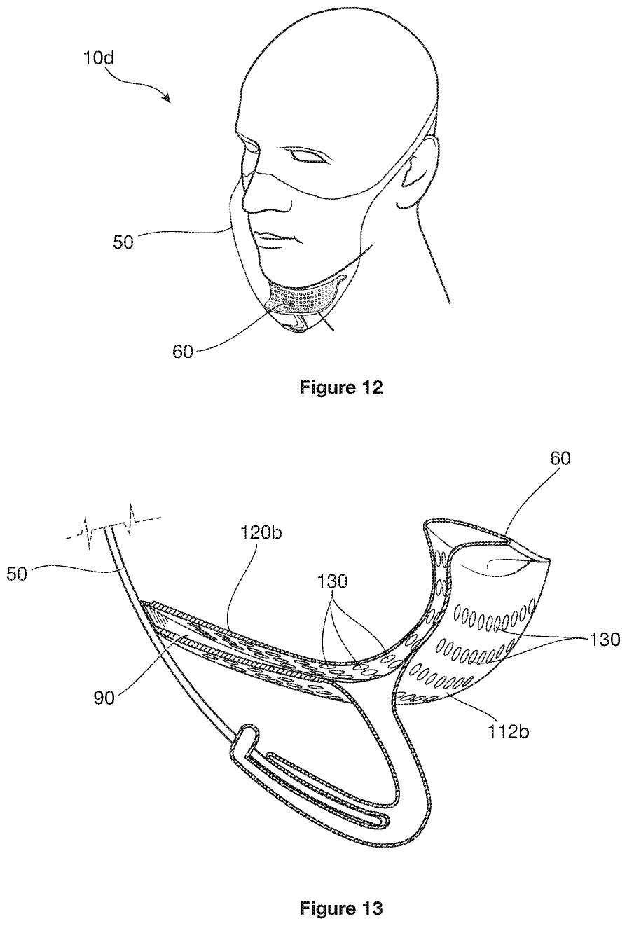

FIGS. 12 and 13 show a mask 10d which is a modified embodiment of the mask 10c. This modified version is very similar to the mask 10c except the main body 112b and retainer 120b of the filter carrier 60 are both shaped as curved planar sections with regularly spaced apertures 130 formed therein. The apertures 130 in the main body 112b and the retainer 120b are not aligned, which forces the air travelling through the filter 90 to change direction between the main body 112b and the retainer 120b, effectively forming a baffle. The baffle also prevents fluids from travelling past the filter 90. This also protects from fluids entering into the mask as the opening is facing the back of the mask behind the main shield and facing the owner's neck. This filter is washable and reusable and allows for a more airflow while still protecting the owner.

The provided mask thus covers the user's respiratory parts without obstruction to the user's face. The filter is also protected by the shield body which protects the filter from rain, debris, mud, etc. and thus increases use of the mask during inclement weather such as rainy days.

In an alternative embodiment, the filter carrier can be permanently attached to the inside surface of the shield body and does not need the attachment arm. The filter carrier can also be formed to include a top slot for insertion of the filter pad therein.

1. A face mask comprising:
a shield comprising a shield body which is shaped and dimensioned to cover the lower front portion of a user's face including the nostrils and mouth, the shield body extending to a distance below the chin which defines an opening space from a lower periphery of the shield body to the user's chin or jaw; and
a filter carrier mounted to a lower portion of the shield body to extend across the opening space in use between the user's chin or jaw and the lower periphery of the shield body such that air moving in and out of the mask passes through a filter carried by the filter carrier.

2. The face mask of claim 1, wherein the shield body is made from transparent material.

3. The face mask of claim 1, wherein the shield body comprises an upper peripheral edge which is shaped to follow the contours of the user's face, and a main mid-portion of the shield body is shaped to be spaced away from the user's face.

4. The face mask of claim 1, wherein the filter carrier comprises a structure having an upper edge which is flexible to seal with the user's chin or jaw in use, and a lower edge which follows and seals with an inside surface of the shield body.

5. The face mask of claim 4, wherein the shield body comprises a lip protrusion formed across an inside surface thereof which is follows the outline of the lower edge of the filter carrier, such that the lower edge of the filter carrier can abut and seal therewith.

6. The face mask of claim 4, wherein the filter carrier comprises a number of openings between the upper edge and the lower edge defined by spaced structural bridges, and wherein the bridges are flexible to allow the user to move their mouth freely in use.

7. The face mask of claim 6, wherein the filter extends across and covers the openings, the filter being removable.

8. The face mask of claim 1, wherein the filter carrier comprises an attachment arm at a lower portion thereof for removable mounting to the shield body.

9. The face mask of claim 1, wherein the filter carrier is permanently attached to the shield body.

10. The face mask of claim 8, wherein the shield body is comprised of a vertical mount slot at the lower periphery thereof and a horizontal mount slot spaced above the vertical slot,
wherein the attachment arm comprises a channel which receives the lower portion of the shield body with a horizontal protrusion at the distal end thereof which is inserted into the horizontal mount slot providing attachment to the shield body, and the attachment arm further comprising a vertical protrusion at the proximal end thereof which is received in the vertical slot to prevent lateral movement of the filter carrier relative to the shield body.

11. The face mask of claim 4, wherein the filter carrier comprises a main body and a retainer with connection means therebetween, and wherein the retainer is removable from the main body and the filter can be mounted between the main body and the retainer.

12. The face mask of claim 11, wherein the main body and the retainer comprise regularly spaced apertures, and wherein the apertures in the main body the retainer are not aligned.

13-26. (canceled)
